(19) United States
(12) Patent Application Publication
(10) Pub. No.: US 2025/0077480 A1
(43) Pub. Date: Mar. 6, 2025

(54) SYSTEMS, APPARATUSES, METHODS, AND COMPUTER PROGRAM PRODUCTS FOR ROBUST DATA INTEGRATION

(71) Applicant: Honeywell International Inc., Charlotte, NC (US)

(72) Inventors: Ankit Singh, Apex, NC (US); Timothy Sneed, Beachwood, NJ (US); Judith Fainor, Doylestown, PA (US); Arun Ramasubrahmanyan, Burlington, NJ (US)

(21) Appl. No.: 18/819,382

(22) Filed: Aug. 29, 2024

Related U.S. Application Data
(60) Provisional application No. 63/535,962, filed on Aug. 31, 2023.

(51) Int. Cl. G06F 16/21

(52) U.S. Cl. CPC G06F 16/212

(57) ABSTRACT

Embodiments provide for robust data integration. Some embodiments configure at least one computing device to establish at least one connection by any one of a plurality of data intake connection types. Each data intake connection type may be configured to facilitate the connection between the at least one computing device with at least one external computing device to access source data stored via the at least one external computing device via a distinct data access protocol. Some embodiments generate a job data object defining at least one data intake connection type. Some embodiments, access particular source data associated with the job data object on at least one particular external computing device, generate a filtered job data object by applying one or more filter data objects to the job data object, and retrieve relevant data from the source data by executing the filtered job data object.

### CROSS REFERENCE TO RELATED APPLICATIONS

This application claims priority to U.S. Provisional Patent Application No. 63/535,962 filed on Aug. 31, 2023, which is incorporated herein by reference in its entirety.

### TECHNICAL FIELD

Embodiments of the present disclosure generally relate to data integration, and specifically to a robust data integration framework.

### BACKGROUND

Various embodiments of the present disclosure address technical challenges associated with data integration. Through applied effort, ingenuity, and innovation, Applicant has solved problems associated with data integration by developing solutions embodied in the present disclosure, which are described in detail below.

### BRIEF SUMMARY

In one aspect, a computer-implemented method for robust data integration is provided. The example computer-implemented method includes configuring at least one computing device to establish at least one connection by any one of a plurality of data intake connection types, each data intake connection type configured to facilitate the connection between the at least one computing device with at least one external computing device to access source data stored via the at least one external computing device via a distinct data access protocol, generating a job data object defining at least one data intake connection type of the plurality of data intake connection types accessing particular source data associated with the job data object on at least one particular external computing device, generating a filtered job data object by applying one or more filter data objects to the job data object, and retrieving relevant data from the source data by executing the filtered job data object, wherein executing the filtered job data object comprises mapping of a data schema associated with the source data to an enterprise object model and accessing the particular at least one external computing device based at least in part on the at least one connection and the filter data objects.

The computer-implemented method further comprising executing at least one workflow based on the relevant data.

The computer-implemented method further comprising storing the enterprise object model in an enterprise object model database associated with a plurality of entities, and processing the stored enterprise object models to generate one or more global enterprise object models.

The computer-implemented method, wherein the plurality of data intake connection types comprises manual upload, pull digital integration, and push integration.

The computer-implemented method, wherein the distinct data access protocol comprises one of direct database access, locally hosted API, client hosted API.

The computer-implemented method, wherein the job data object includes one or more of data source URL, data destination URL, authentication data, or data fields defined by one or more object types.

The computer-implemented method, wherein generating the job data object comprises receiving the job data object from the at least one external computing device.

The computer-implemented method, wherein the one or more filter data objects comprise one or more of date range, site information, or batch data.

The computer-implemented method, wherein mapping of a data schema associated with the source data to an enterprise object model comprise mapping an object type associated with the source data table to an object type associated with the data destination table.

In another aspect, an apparatus for robust data integration is provided. The example apparatus includes at least one processor and at least one non-transitory memory having computer program code stored thereon that, in execution with the at least one processor, causes the apparatus to perform any one of the example computer-implemented methods described herein.

In another aspect, a computer program product for robust data integration is provided. The example computer program product includes at least one non-transitory computer-readable storage medium having computer program code stored thereon that, in execution with at least one processor, configures the computer program product to perform any one of the example computer-implemented methods described herein.

### BRIEF DESCRIPTION OF THE SEVERAL VIEWS OF THE DRAWINGS

Having thus described the embodiments of the disclosure in general terms, reference now will be made to the accompanying drawings, which are not necessarily drawn to scale, and wherein:

FIG. 1 illustrates a block diagram of an example environment in which embodiments of the present disclosure may operate.

FIG. 2 illustrates a block diagram of an example apparatus in accordance with at least one example embodiment of the present disclosure.

FIG. 3 illustrates an example data flow diagram for robust data integration in accordance with at least one example embodiment of the present disclosure.

FIG. 4 illustrates an example data integration framework in accordance with at least one example embodiment of the present disclosure.

FIG. 5 illustrates an example data flow for an example pull-based data integration in accordance with at least one example embodiment of the present disclosure.

FIG. 6 illustrates a signal diagram of an example authorization code flow associated with an example pull-based data intake connection in accordance with at least one example embodiment of the present disclosure.

FIG. 7 illustrates a signal diagram of an example workflow generation in accordance with at least one example embodiment of the present disclosure.

FIG. 8 illustrates an example data flow for an example push-based data integration in accordance with at least one example embodiment of the present disclosure.

FIG. 9 illustrates an example system architecture for data integration with external system of records in accordance with at least one example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based on in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### OVERVIEW AND TECHNICAL IMPROVEMENTS

Embodiments of the present disclosure provide a robust data integration framework that allows a user to connect to any of multiple system of records. In particular, the data integration framework according to various embodiments provides multiple modes of data connection that enables a user to connect to desired system of records.

Embodiments of the present disclosure provide capabilities that enables comprehensive data to be accessed and/or aggregated from various disparate system of records in a secure manner for use in and/or by various applications and systems, which in turn improves the functionalities of such applications. In particular, example, embodiments, provide for secure integration with such applications and systems via any of various connection types manual upload-based connection types, data pull-based connection types, data push-based connection types, cloud-based connection types, and/or the like. For example, a computing device (e.g., associated with an enterprise) may be integrated with a system (which may be a third-party system) such as a trackwise digital system. Such system, for example, may be a cloud-based quality management system (QMS) configured to provide functionalities (e.g., quality compliance, artificial intelligence-based reports, and/or the like) that may depend at least in part on access (e.g., in real-time, periodically, on-demand, and/or the like) to various disparate data associated with an enterprise (e.g., batch data, manufacturing data, lab results data, CRM data, ERP data, process related data, and/or the like).

In this regard, by providing such robust data integration framework as disclosed herein, embodiments of the present disclosure facilitates and enables various applications and systems to generate fast, accurate, and meaningful outputs. In an example implementation, such output may include quality reports (e.g., HPQR reports, and/or the like), dashboards/interfaces comprising meaning insights (e.g., QSMR dashboards/user interfaces or the like), packages (e.g., product recall submission packages, and/or the like).

In this regard, embodiments of the present disclosure provide various technical advantages and improves various technologies (e.g., the functioning of various technologies) and technical fields. In particular, embodiments of the present disclosure provide various technical advantages in the technical field of data processing and analysis as well as the functioning of applications, digital platforms, systems, and/or the like that rely on quality and/or large amount of data.

### Definitions

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

In some embodiments, the terms “computing device” may refer to a computer comprising at least one processor and at least one memory. In some embodiments, the computing device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. In some examples, a “computing device” may refer to computer hardware and/or software that is configured to access a service made available by a server. The server is often, but not always, on another computer system, in which case the client accesses the service by way of a network. Embodiments of client devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like. In some embodiments, a computing device may be associated with a system, such as, for example, a data integration system.

In some embodiments, the term “external computing device” may refer to a computing device that is external to a system, such as, for example, a data integration system. For example, an external computing device may be configured to communicate with a data integration system.

### Example Systems and Apparatuses of the Disclosure

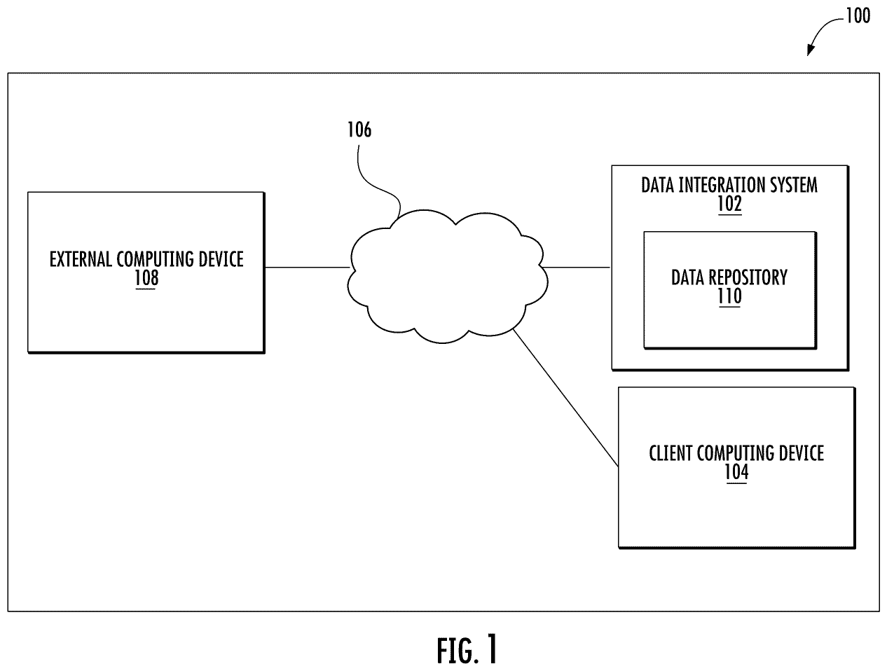

FIG. 1 illustrates a block diagram of an example environment 100 within which embodiments of the present disclosure may operate. Specifically, FIG. 1 illustrates an example data integration system 102 and one or more external computing devices 108. The data integration system 102 and the one or more external computing devices 108 may communicate with each other over one or more communications network(s), for example a communications network 106. In some embodiments, data integration system 102 may be associated with and/or comprise one or more client computing devices 104. Alternatively or additionally, in some embodiments, the client computing devices 104 may be associated with an enterprise (e.g., business, an organization, and/or the like). In some embodiments, the one or more external computing device 108 and the one or more client computing devices may communicate with each other over one or more communications network(s), for example a communications network 106.

It should be appreciated that the communications network 106 in some embodiments is embodied in any of a myriad of network configurations. In some embodiments, the communications network 106 embodies a public network (e.g., the Internet). In some embodiments, the communications network 106 embodies a private network (e.g., an internal localized, or closed-off network between particular devices). In some other embodiments, the communications network 106 embodies a hybrid network (e.g., a network enabling internal communications between particular connected devices and external communications with other devices). The communications network 106 in some embodiments includes one or more base station(s), relay(s), router(s), switch(es), cell tower(s), communications cable(s) and/or associated routing station(s), and/or the like. In some embodiments, the communications network 106 includes one or more user controlled computing device(s) (e.g., a user owned router and/or modem) and/or one or more external utility devices (e.g., Internet service provider communication tower(s) and/or other device(s)).

Each of the components of the environment 100 may be communicatively coupled to transmit data to and/or receive data from one another over the same or different wireless and/or wired networks embodying the communications network 106. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 106, the various embodiments are not limited to this architecture. In other embodiments, one or more computing entities share one or more components, hardware, and/or the like, or otherwise are embodied by a single computing device such that connection(s) between the computing entities over the communications network 106 are altered and/or rendered unnecessary. For example, in some embodiments, the one or more external computing devices 108 includes some or all of the data integration system 102, such that an external communications network 106 is not required.

In some embodiments, the data integration system 102 and the one or more external computing devices 108 are embodied in an on-premises system within or associated with an entity, for example, an enterprise. In such some embodiments, the data integration system 102 and the one or more external computing devices 108 may be communicatively coupled via at least one wired connection. Alternatively or additionally, in some embodiments, the one or more external computing devices 108 includes the data integration system 102, for example as a software component of a single enterprise terminal. In some embodiments, an enterprise refers to an entity such as a business, an organization, and/or the like. In some examples, an enterprise may produce products of various types via various research, manufacturing, and/or distribution processes associated with production of these products. In some example, an enterprise may develop, implement, and/or utilize one or more systems (e.g., management system, process control systems, and/or the like), processes, and/or operations with respect to the research, manufacturing, and/or distribution processes for one or more purposes. For example, an enterprise may develop, implement, and/or utilize a quality management system to ensure product quality and/or ensure adherence to industry quality standards or regulations. In a medical context, for example, production of certain products (e.g., pharmaceutical products, medical equipment, and/or the like) may be subject to a relatively high degree of quality management standard and/or regulation. In some examples, one or more applications may be utilized to implement and/or facilitate various functionalities of an enterprise's system. For example, a quality management software, such as, for example, an APQP, APQR, and/or the like may be utilized to implement and/or facilitate quality management and/or control measures undertaken by enterprises with respect to the production of their products. In some contexts, the system may be capable of facilitating and/or performing various functions including, for example, performing one or more workflows based on data associated with the enterprise (e.g., based on relevant data obtained from various data associated with the enterprise).

The data integration system 102 may include any number of computing device(s) and/or system(s) (e.g., server system) configured, for example, via hardware, software, firmware, and/or a combination thereof, to facilitate and/or perform various functionalities associated with data integration. For example, in some embodiments, the data integration system 102 may include any number of computing device(s) and/or system(s) configured for establishing connection between a computing device and an external computing device. In some embodiments, the data integration system 102 includes, embodies or is otherwise associated with the computing device. For example, in some embodiments, the data integration system 102 may include any number of computing device(s) and/or system(s) configured for establishing connection between a computing device associated with the data integration system 102 and an external computing device.

In some embodiments, the data integration system 102 may include any number of computing device(s) and/or system(s) configured for identifying, retrieving, receiving, and/or storing data associated with data integration in one or more data repositories 110. Alternatively or additionally, the data integration system 102 may include any number of computing device(s) and/or system(s) configured for identifying, retrieving, receiving, and/or storing data associated with executing one or more applications (e.g., software application, web application, and/or the like). For example, in some embodiments, the data integration system 102 may facilitate and/or cause execution of one or more workflows by an application.

In some embodiments, the one or more external computing devices 108 may be associated with and/or operated by users of the one or more applications. In some embodiments, the one or more applications may be associated with, hosted by, and/or provided by the same entity associated with the data integration system 102.

The one or more data repositories 110 may be configured to receive, store, and/or transmit data. In some embodiments, the one or more data repositories 110 may be configured to store data received from the one or more external computing devices 108. In some embodiments, the one or more data repositories 110 may be configured to store data associated with facilitating and/or performing various functionalities associated with data integration including, for example, data associated with establishing connection between a computing device and an external computing device 108, data associated with generating object models, data associated with mapping object models, and/or the like. In some embodiments, some or all of the data stored in the one or more data repositories 110 may be stored in a shared memory. In some embodiments, some or all of the data stored in the one or more data repositories 110 may be stored in different memory systems.

In some embodiments, the data integration system 102 may include any number of computing device(s) and/or system(s) configured for accessing, analyzing, parsing, and/or retrieving configuration data and/or other data stored in the one or more data repositories 110. In some embodiments, the configuration data and/or other data may be utilized in executing one or more workflows (e.g., by an application).

In some embodiments, the data integration system 102 may include any number of computing device(s) and/or system(s) configured for establishing a connection by anyone of a plurality of data intake connection types. In some embodiments, a data intake connection type may be configured to facilitate a connection between a computing device and an external computing device 108 to access source data stored via an external computing device 108 via a distinct data access protocol. For example, in some embodiments, each data intake connection type of a plurality of data intake connection types may be configured to facilitate a connection between a computing device and an external computing device 108 to access source data stored via an external computing device 108 via a distinct data access protocol.

In some embodiments, the data integration system 102 may include any number of computing device(s) and/or system(s) configured for generating a job data object defining at least one data intake connection of a plurality of data intake connections. In some embodiments, the data integration system 102 may include any number of computing device(s) and/or system(s) configured for accessing particular source data associated with a job data object on a particular external computing device 108. In some embodiments, the data integration system 102 may include any number of computing device(s) and/or system(s) configured for generating a filtered job data object, for example, by applying one or more filter data objects to a job data object. In some embodiments, the data integration system 102 may include any number of computing device(s) and/or system(s) configured for retrieving relevant data from source data stored in the one or more repositories, for example, by executing a filtered job data object. In some embodiments, executing a filtered job data object includes mapping of a data schema associated with the source data to an enterprise object model. In some embodiments, executing the source data includes accessing an external computing device 108, for example, based at least in part at least one connection and a filter data object(s). In some embodiments, executing a filtered job data object includes executing at least one workflow based on relevant data retrieved from source data.

While FIG. 1 illustrates certain components as separate, standalone entities communicating over the network 106, various embodiments are not limited to this configuration. In other embodiments, one or more components may be directly connected and/or share hardware or the like.

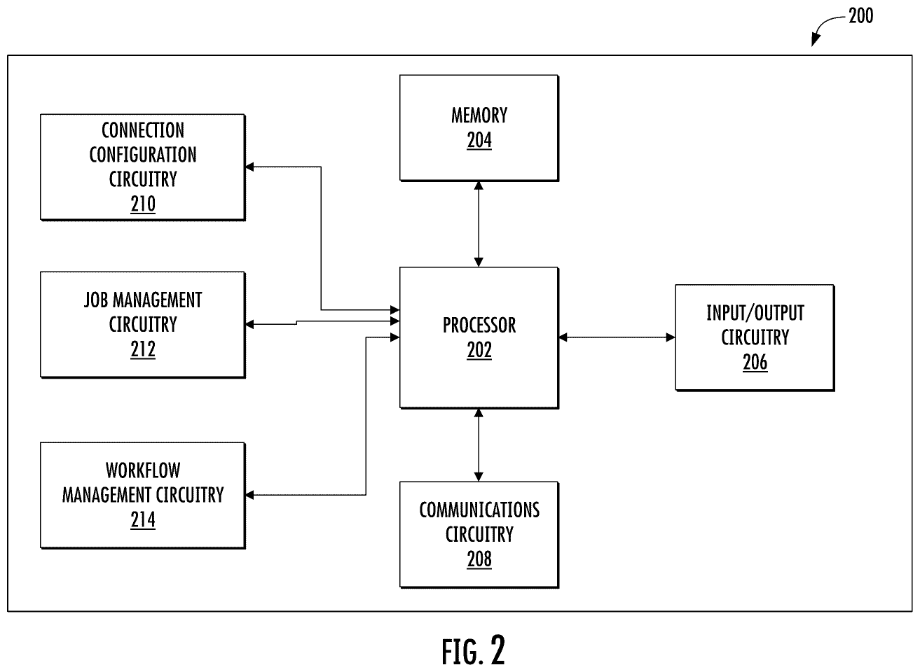

FIG. 2 illustrates a block diagram of an example apparatus in accordance with at least one example embodiment of the present disclosure. Specifically, FIG. 2 depicts an example apparatus 200 (“apparatus 200”) specially configured in accordance with at least some example embodiments of the present disclosure. In some embodiments, the data integration system 102 and/or a portion thereof is embodied by one or more system(s), such as the apparatus 200 as depicted and described in FIG. 2. The apparatus 200 includes processor 202, memory 204, input/output circuitry 206, communications circuitry 208, connection configuration circuitry 210, job management circuitry 212, and/or optional workflow management circuitry 214. In some embodiments, the apparatus 200 is configured, using one or more of the sets of circuitry embodied by processor 202, memory 204, input/output circuitry 206, communications circuitry 208, connection configuration circuitry 210, job management circuitry 212, and/or optional workflow management circuitry 214, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, products/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. In some embodiments, the processor 202 includes hardware, software, firmware, and/or a combination thereof that performs one or more operations described herein.

As one particular example embodiment, the processor 202 is configured to perform various operations associated with configuring a computing device (e.g., embodied by or otherwise associated with the data integration system) to establish connection with another computing device (e.g., external computing device 108) by any of one of a plurality of data intake connection types. In such one particular example embodiment, the processor 202 may be configured to perform various operations associated with generating job data object(s), where a job data object may define at least one data intake connection type. In such one particular example embodiment, the processor 202 may be configured to perform various operations associated with accessing source data associated with a job data object on an external computing device. In such one particular example embodiment, the processor 202 may be configured to perform various operations associated with generating filtered data object(s). In such one particular example embodiment, the processor 202 may be configured to perform various operations associated with executing a filtered data object to retrieve relevant data from source data.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a user device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

In some embodiments, the apparatus 200 includes connection configuration circuitry 210. The connection configuration circuitry 210 may include hardware, software, firmware, and/or a combination thereof, configured to request, receive, process, generate, and transmit data, data structures, control signals, and electronic information for configuring a computing device (e.g., embodied by or otherwise associated with the data integration system 102) to establish connection with another computing device (e.g., external computing device 108) by any of one of a plurality of data intake connection types, including performing any of the operations described herein with respect to data integration. The connection configuration circuitry 210 may include hardware, software, firmware, and/or a combination thereof, configured to request, receive, process, generate, and transmit data, data structures, control signals, and electronic information for generating job data object(s), where a job data object may define at least one data intake connection type. In some embodiments, the connection configuration circuitry 210 includes a separate processor, specially configured field programmable gate array (FPGA), or a specially programmed application specific integrated circuit (ASIC).

In some embodiments, the apparatus 200 includes job management circuitry 212. The job management circuitry 212 may include hardware, software, firmware, and/or a combination thereof, configured to request, receive, process, generate, and transmit data, data structures, control signals, and electronic information for accessing source data associated with a job data object on an external computing device, including performing any of the operations described herein with respect to accessing source data.

The job management circuitry 212 may include hardware, software, firmware, and/or a combination thereof, configured to request, receive, process, generate, and transmit data, data structures, control signals, and electronic information for generating filtered data object(s).

The job management circuitry 212 may include hardware, software, firmware, and/or a combination thereof, configured to request, receive, process, generate, and transmit data, data structures, control signals, and electronic information for executing a filtered data object to retrieve relevant data from source data. In some embodiments, the job management circuitry 212 includes a separate processor, specially configured field programmable gate array (FPGA), or a specially programmed application specific integrated circuit (ASIC).

In some embodiments, the apparatus 200 includes optional workflow management circuitry 214. The optional workflow management circuitry 214 may include hardware, software, firmware, and/or a combination thereof, configured to request, receive, process, generate, and transmit data, data structures, control signals, and electronic information for executing one or more workflows, including performing any of the operations described herein with respect to executing workflow(s). In some embodiments, the optional workflow management circuitry 214 includes a separate processor, specially configured field programmable gate array (FPGA), or a specially programmed application specific integrated circuit (ASIC).

In some embodiments, two or more of the sets of circuitries embodying processor 202, memory 204, input/output circuitry 206, communications circuitry 208, connection configuration circuitry 210, job management circuitry 212, and/or optional workflow management circuitry 214. Alternatively or additionally, in some embodiments, one or more of the sets of circuitry perform some or all of the functionality described associated with another component. For example, in some embodiments, two or more of the sets of circuitry embodied by processor 202, memory 204, input/output circuitry 206, communications circuitry 208, connection configuration circuitry 210, job management circuitry 212, and/or optional workflow management circuitry 214, are combined into a single module embodied in hardware, software, firmware, and/or a combination thereof. Similarly, in some embodiments, one or more of the sets of circuitry, for example connection configuration circuitry 210, job management circuitry 212, and/or optional workflow management circuitry 214, is/are combined with the processor 202, such that the processor 202 performs one or more of the operations described above with respect to each of these sets of circuitry embodied by the connection configuration circuitry 210, job management circuitry 212, and/or optional workflow management circuitry 214.

### Example Processes of the Disclosure

Having described example apparatuses, systems, and environments in accordance with the disclosure, processes for robust data integration in accordance with the disclosure will now be described. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depicts a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

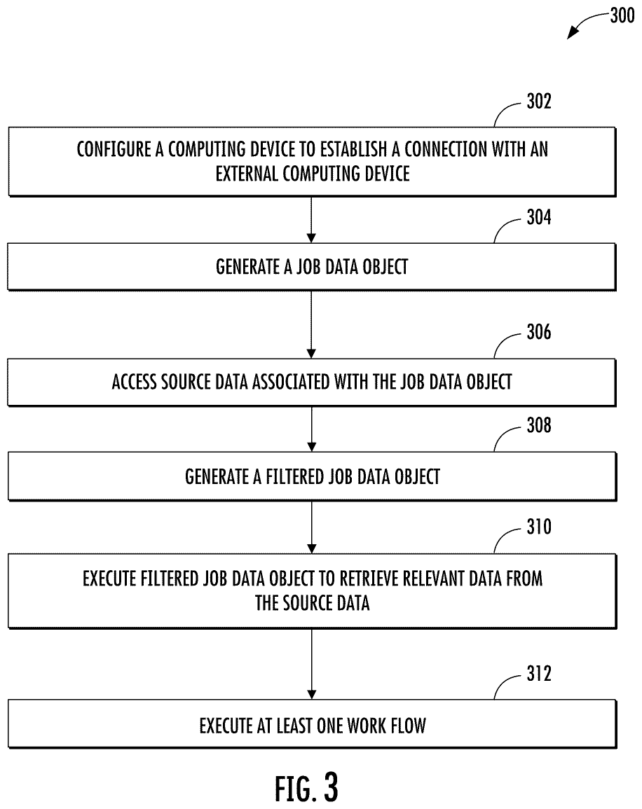

FIG. 3 illustrates a flowchart depicting operations of an example process for robust data integration in accordance with at least one example embodiment of the present disclosure. Specifically, FIG. 3 depicts an example process 300. In some embodiments, the process 300 is embodied by computer program code stored on a non-transitory computer-readable storage medium of a computer program product configured for execution to perform the process as depicted and described. Alternatively or additionally, in some embodiments, the process 300 is performed by one or more specially configured computing devices, such as the apparatus 200 alone or in communication with one or more other component(s), device(s), system(s), and/or the like. In this regard, in such some embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one external data repository, client system, and/or the like, to perform one or more of the operation(s) as depicted and described. For purposes of simplifying the description, the process 300 is described as performed by and from the perspective of the apparatus 200.

According to some examples, the method includes configuring a computing device to establish a connection with an external computing device at operation 302. In some embodiments, one or more of a plurality of data intake connection types may be leveraged to establish the connection. For example, the apparatus 200 may configure at least one computing device to establish at least one connection with at least one external computing device by any one of a plurality of data intake connection types. Each data intake connection type of the plurality of data intake connection types may be configured to facilitate a connection between a computing device with an external computing device to access data stored via the external computing device. Each data intake connection type may be associated with one or more access protocols. For example, in some embodiments each data intake connection type is associated with a distinct access protocol and is configured to facilitate a connection with an external connection type via the distinct access protocol. For example, in some embodiments, the apparatus 200 configures at least one computing device to establish at least one connection by any one of the plurality of data intake connection types, where each data intake connection type is configured to facilitate the connection between the at least one computing device with the at least one external computing device to access source data stored via the at least one external computing device via a distinct data access protocol.

In some embodiments, the plurality of data intake connection types include manual upload, digital integration, non-digital integration, and/or the like. In some embodiments, digital integration may include pull digital integration, push digital integration, and/or the like. For example, in some embodiments, digital integration may leverage data pull technique and/or data push technique to facilitate the connection between the computing device and the external computing device to access data stored via the external computing device. In some examples, digital integration is cloud-based (e.g., implemented using a cloud framework), In some embodiments, non-digital integration may include pull non-digital integration, push non-digital integration, and/or the like. For example, in some embodiments, non-digital integration may leverage data pull technique and/or data push technique to facilitate the connection between the computing device and the external computing device to access data stored via the external computing device. In some examples, non-digital integration is on premises-based (e.g., implemented on premises. In some embodiments, the data intake connection type is configurable. In some embodiments, the data intake connection type is user-configurable.

In some embodiments, the distinct data access protocol includes direct database access, locally hosted application programming interface (API), client hosted API, and or the like. For example, the distinct data access protocol may comprise one of direct database access, locally hosted API, or client hosted API in some embodiments.

According to some examples, the method includes generating a job data object at operation 304. In some embodiments, generating the job data object includes receiving the job data object from the at least one external computing device. In some embodiments, the job data object defines at least one data intake connection type of the plurality of data intake connection types. For example, the apparatus 200 may generate a job data object defining at least one data intake connection type of the plurality of data intake connection types. In some embodiments, generating the job data object includes receiving input from the at least one external computing device that define one or parameters leveraged by the apparatus 200 to create the job data object. In some embodiments, generating the job data object may include receiving the job data object from the external computing device.

In some embodiments, the job data object includes data source uniform resource locator (URL), data destination URL, authentication data, data fields defined by one or more object types (e.g., table information, column information, and/or the like), and/or the like. For example, the job data object may include one or more of data source URL, data destination URL, authentication data, or data fields defined by one or more object types in some embodiments.

According to some examples, the method includes accessing particular source data associated with the job data object at operation 306. For example, the apparatus 200 may access particular source data associated with the job data object on at least one particular external computing device.

According to some examples, the method includes generating a filtered job data object at operation 308. In some embodiments, the filtered data object is generated by applying one or more filter data objects to the job data object. For example, in some embodiments, the apparatus 200 generates a filtered job data object by applying one or more filter data objects to the job data object. In some embodiments, a filer data object may be applied to a job data object via an APL

In some examples, the one or more filter data objects may define or otherwise include one or more filters leveraged to pull at least a portion of the source data, for example, a desired portion of the source data. In some examples, the one or more filter data objects includes date range, site information, batch data, and/or the like. By way of example, applying one or more filter data objects to a job data object may include performing one or more filtering operations on at least a portion of the source data, for example, based on date range, site information, batch information, and/or the like.

According to some examples, the method includes retrieving relevant data from the source data at operation 310. In some embodiments, the relevant data is retrieved by executing the filtered job data object. For example, in some embodiments, the apparatus 200 retrieves relevant data from the source data by executing the filtered job data object. In some embodiments, executing the filtered data object includes mapping of a data schema associated with the source data to an enterprise object model and/or accessing the external computing device based at least in part on the at least one connection (e.g., established at operation 302) and/or the filter data objects.

In some embodiments, an object model may refer to electronically managed data embodying a configuration of a data object and/or a collection of data objects that are generable, storable, processable, and/or otherwise interactable within a system. For example, an object model may be configured to store data using objects, that for example, includes one or more fields for storing data. An object model, for example, may include a number of fields which may correspond to columns in database. For example, an object model may be represented as a table, where a field represents a column in the table and/or a record represents a row in the table. In some examples, custom data object may be represented in an object model.

An example of an object model includes an enterprise object model. In some examples, an enterprise object model may describe an object model that is associated with one or more enterprises. For example, an enterprise object model may be associated with a particular enterprise and/or may be associated with multiple enterprises (e.g., having one or more characteristics in common). An example of an enterprise object model is LIMS enterprise object model (e.g., generated based on LIMS data associated with one or more enterprises). In some examples, an enterprise object model may be customizable. Another example of an object model is a global object model. A global object model (global enterprise object model) may describe an object model that is associated with a plurality of enterprises. In some examples, a global object model may be generated based on a plurality of enterprise object models associated with one or more enterprises. In some embodiments, generating a global object model may include identifying common attributes among a plurality of enterprise object models.

In some examples, mapping of a data schema associated with the source data to an enterprise object model includes mapping an object type associated whit a data structure associated with the source data to an object type associated with a data structure associated with a data storage destination. The data storage destination, for example, may include one or more databases associated with a data integration system, such as data integration system 102 discussed herein. For example, the data storage destination may include one or more data repositories 110, In some examples, the data structure associated with the source data may include a table data structure (e.g., source data table) leveraged to store, organize, and/or the like data associated with the data source. In some embodiments, the data structure associated with the storage destination may include a table data structure (e.g., data destination table) leveraged to store, organize, and/or the like data retrieved from the source data, for example, relevant data retrieved from the source data. In some examples, mapping of a data schema associated with the source data to an enterprise object model may include mapping a source data table to a destination data table. For example, an example of mapping of a data schema associated with the source data to an enterprise object model may include mapping a salesforce table to an AWS table.

In some examples, mapping of a data schema associated with the source data to an enterprise object model comprise mapping an object type associated with a table associated with the source data (e.g., source data table) to an object type associated with a destination table (e.g., data destination table).

In some embodiments, the enterprise object model is stored in an enterprise object model database associated with a plurality of entities. In some embodiments, one or more stored enterprise models are processed to generate one or more global enterprise object models. In some embodiments, an enterprise object model may be leveraged to map a data schema associated with source data of a particular enterprise and/or a global object model may be leveraged to map a data schema associated with source data of any of a plurality of enterprises.

According to some examples, the method includes executing at least one workflow based on the relevant data at operation 312. An example of a workflow may include generating a report, generating configuration data for a report, performing data analysis, and/or the like.

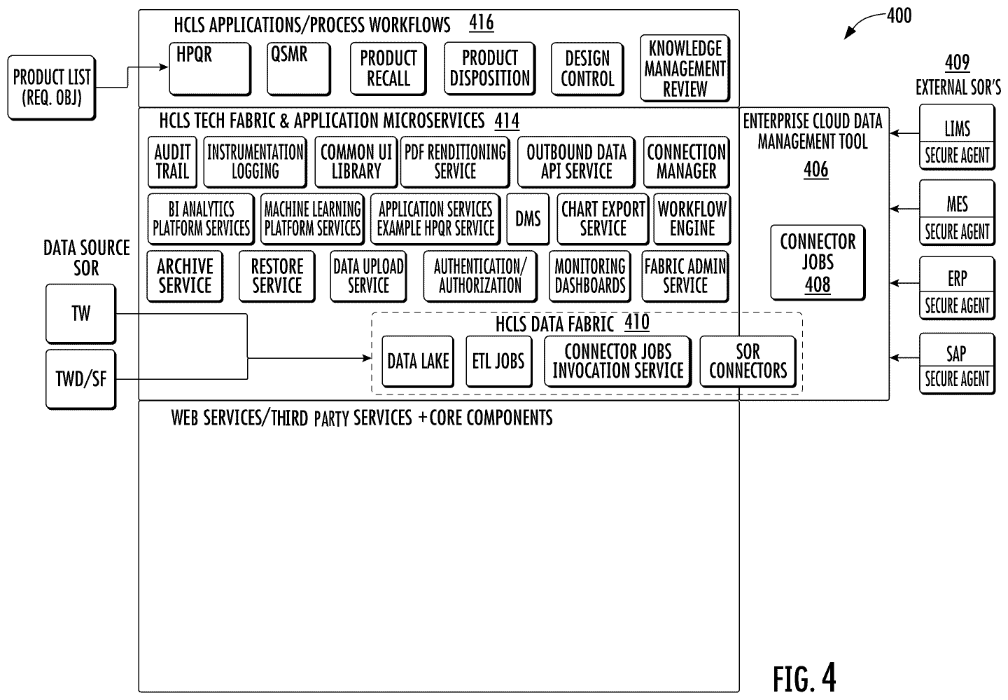

FIG. 4 illustrates an example data integration framework in accordance with at least one example embodiment of the present disclosure. In particular, FIG. 4 illustrates an example data integration framework 400 for configuring at least one computing device to establish at least one connection by any one of the plurality of data intake connection types including, but not limited to, manual upload, pull-based data intake connection, push-based data intake connection, and/or the like. In particular, manual-based data integration, pull-based data integration, and/or push-based data integration may be implemented using the data integration framework 400. As described above, each data intake connection type may be configured to facilitate connection between at least one computing device and at least one external computing device such that the at least one computing device may access source data stored via the at least one external computing device via a distinct data access protocol.

The data integration framework 400 may include an enterprise cloud data management module 406 (illustrated as enterprise cloud data management tool 406 in FIG. 4). The enterprise cloud data management module 406 may comprise a connection configuration circuitry (e.g., such as connection configuration circuitry 210) or configured to facilitate and/or perform one or more of the functionalities of the connection configuration circuitry 210 such as, but not limited to, requesting, receiving, processing, generating, and/or transmitting data, data structures, control signals, and electronic information for configuring a computing device (e.g., embodied by or otherwise associated with the data integration system 102) to establish connection with another computing device (e.g., external computing device 108) by any of one of the plurality of data intake connection types, including facilitating and/or performing any of the operations described herein with respect to data integration.

The enterprise cloud data management module 406, for example, may be configured to request, receive, process, generate, and transmit data, data structures, control signals, and/or electronic information for generating job data object(s) 408 (referred to as connector jobs in FIG. 4). In a particular example, the enterprise cloud data management module 406 may be configured receive job data objects from a computing device (e.g., a computing device associated with an enterprise). As described above a job data object may define at least one data intake connection type of a plurality of data intake connection types. The plurality of data intake connection types may each indicate or otherwise point to a particular system of record (SOR) of a plurality of system of records. The plurality of system of records may include external system of records 409 such LIMS, MES, ERS, SAP, and/or the like.

The enterprise cloud data management module 406 may be configured to access various data sources or otherwise receive data from various data sources, where the various data sources may be associated with disparate data schemas or otherwise associated with disparate system or records (SORs). For example, at least two data source of the various data sources may be associated with different system of records. The data schema for the system of records associated with the two data sources, for example, may be different. In this regard, the data management module 406 may be configured to access and/or receive data from any of a plurality of different data sources.

The data integration framework 400 may include a data fabric module 410 (illustrated as data fabric 410 in FIG. 4). The data fabric module 410 may comprise a job management circuitry (e.g., job management circuitry 212) or otherwise associated with a job management circuitry such as job management circuitry 212. The data fabric module 410 (e.g., job management circuitry thereof) may be configured to perform the functionalities associated with the job management circuitry 212 including, but not limited to, requesting, receiving, processing, generating, and/or transmitting data, data structures, control signals, and/or electronic information for accessing source data associated with a job data object on an external computing device, including performing any of the operations described herein with respect to accessing source data.

The data fabric module 410 (e.g., job management circuitry thereof), for example, may be configured to request, receive, process, generate, and transmit data, data structures, control signals, and electronic information for generating filtered data object(s) and/or executing filtered data object(s) as described above. The data fabric module 410 may include one or more components and may leverage such one or more components to perform one or more functionalities associated with the data fabric module 410. The data fabric module 410, for example, may include a data lake (e.g., a database/repository), connector jobs innovation service, SOR connectors, extract, transform, load (ETL) jobs, and/or the like. The SOR connectors, for example, may be configured to enable access to disparate systems of records.

In some embodiments, the data fabric module 410 includes the connection configuration circuitry 210 or may be configured to perform one or more functionalities associated with the connection configuration circuitry 210. In some embodiments, the fabric module 410 and the and the enterprise cloud data management module 406 may be configured to individually and/or collectively perform the functionalities associated with the connection configuration circuitry 210. For example, in some embodiments, the enterprise cloud data management module 406 may be configured to access various data sources or otherwise receive data from various data sources, where the various data sources may be associated with disparate data schemas or otherwise associated with disparate system or records (SORs), which may include external SORs and/or internal SORs with respect to the data integration system 102. By way of example, the system 102 may be associated with or otherwise communicatively coupled to an internal SOR such as Sparta SOR.

The data integration framework 400 may include a workflow management module 414 (illustrated as HCLS Tech Fabric 414 in FIG. 4). The workflow management module 414 may comprise a workflow management circuitry or otherwise associated with workflow management circuitry such as a workflow management circuitry 214. The workflow management module 414 may be configured to perform the functionalities associated with the workflow management circuitry 214, including but not limited to, requesting, receiving, processing, generating, and/or transmitting data, data structures, control signals, and/or electronic information for executing one or more workflows such as, for example, process workflows 416 illustrated in FIG. 4. For example, in some implementations, the one or more workflows may include a product quality review (PQR) workflow (e.g., such as HPQR), a quality management review workflow (e.g., such as QSMR), product recall workflow, product disposition workflow, design control workflow, knowledge management review workflow. The workflows for example may depend on the domain (e.g., life sciences domain, and/or the like).

As shown in FIG. 4, the workflow management module 414 may include or is otherwise associated with one or more microservices and/or other components. The workflow management module 414 may leverage the one or more microservices and/or other components to facilitate and/or perform one or more of the functionalities of the workflow management module 414. Non-limiting examples of such one or more microservices and/or other components include audit trail, instrumentation logging, common UI library, PDF renditioning service, outbound data API services, connection manager, BI analytics platform services, machine learning platform services, application services example HPQR service, DMS, chart export service, workflow engine, archive service, restore service, data upload service, authentication/authorization, monitoring dashboards, fabric admin service, and/or the like.

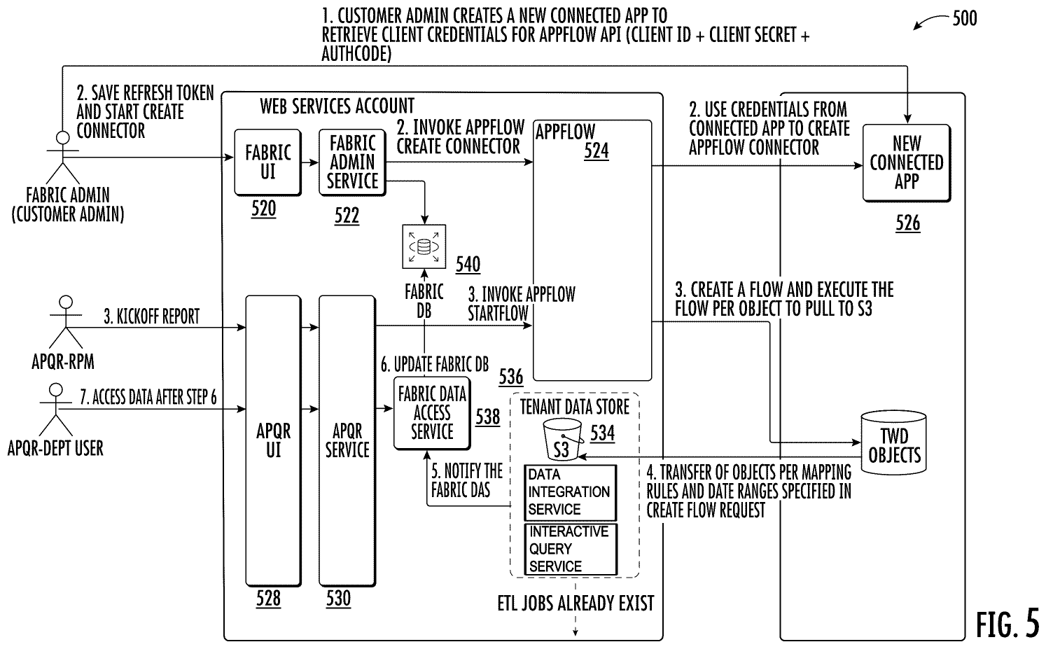

FIG. 5 illustrates an example data flow 500 for an example pull-based data integration in accordance with at least one example embodiment of the present disclosure. In particular FIG. 5 illustrates an example data flow 500 for a pull-based data intake connection for integration with a system (which may be a third-party system in some examples) such as trackwise digital system. In an example embodiment, the data flow 500 may be implemented to run as on on-demand app flow pulls using filters (e.g., date range filters, and/or the like) for specific objects (e.g., associated with specific object models). In some other embodiments, a given object hierarchy may be remapped using the fabric admin user interface. In some embodiments, a given object hierarchy may be mapped using the specific object hierarchy.

In some embodiments, client credentials is retrieved. The client credentials may include client identification (e.g., client id, client secret data, and/or authorization code). In some embodiments, the client credentials may be retrieved by a customer admin agent. In some embodiments, retrieving the client credentials may comprise creating a connected application (“connected app”). For example, a customer admin agent may create a connected app to retrieve client credentials in some embodiments.

In some embodiments, an application flow connector is created based at least in part on the client credentials to establish connection to a connected application 526. In some embodiments, creating the application flow connector comprises initiating/invoking an application flow creator connector and using the client credentials to create the application flow connector.

In some embodiments, a fabric admin service 522 is leveraged to create the application flow connector. The data integration system 102, for example, may be associated with and/or include one or more services and/or microservices including, but not limited, to a fabric admin service 522. The fabric admin service 522 may be configured to facilitate establishing/creating the application workflow connector in response to receiving indication of an application flow connector request. The fabric admin service 522 may receive the indication of the application flow connector request via a user interface such as fabric admin user interface 520. The data integration system 102, for example, may be associated with and/or provide one or more user interfaces including, but not limited to, a fabric admin user interface 520.

The fabric admin user interface 520 may configured for rendering on a computing device such that user input may be received via the user interface. Such user input may comprise an application flow connection request. The fabric admin service 522 may communicate with an application flow module/system 524 to cause the application flow module/system 524 to create the application flow connector using the client credentials such that a connected application 526 is established. In some embodiments, the application flow module/system 524 may be associated with and/or comprise a third-party system. An example of an application flow module/system is AWS AppFlow.

In some embodiments, a fabric admin agent may initiate establishing of the connector application 526. For example, the fabric admin agent may trigger creation/establishing of the connected application 526 via the fabric admin user interface 520.

In some embodiments, a workflow (e.g., an application workflow) may be created and executed. In some embodiments, creating and executing a workflow comprises initiating a report generation process via a corresponding report user interface 528. By way of example, an annual product quality (APQR) report may generation process may be initiated via an APQR user interface. The data integrations system 102, for example may be associated with and/or provide the report user interface for rendering on a computing device such that user input including, but not limited to, workflow request, may be received via the report user interface 528.

In some embodiments, a service/microservices such as a report service 530 (e.g., APQR service, APQP service, and/or the like) is leveraged to facilitate creation and/or execution of the workflow. The report service 530 may be configured to facilitate creation and/or execution of the workflow in response to receiving indication of a workflow request. The report service 530 may receive an indication of the workflow request via the report user interface 528 and cause the application flow module to create a create a corresponding workflow and execute the workflow. In some embodiments, a report (e.g., APQR report, APQP report, and/or the like) corresponding the workflow request is generated.

In some embodiments, the workflow is executed per object to pull to a database 534 such as, for example, S3 database(s). In some embodiments, the objects are transferred into such database(s) based on mapping rules and/or filters (e.g., date ranges, and/or the like) specified in the workflow request. The data integration system 102 may include a tenant data store 536 that comprises the database 534. Further, the data integration system 102 may include a fabric data access service 538 configured to receive notification indicating transfer of the objects to the database 534 and update a fabric database 540 associated with the data integration system 102 in response to the notification. In some embodiments, the workflow and/or report (e.g., output of the workflow execution) may be caused to be displayed on the report user interface 528 such that a user may access the report.

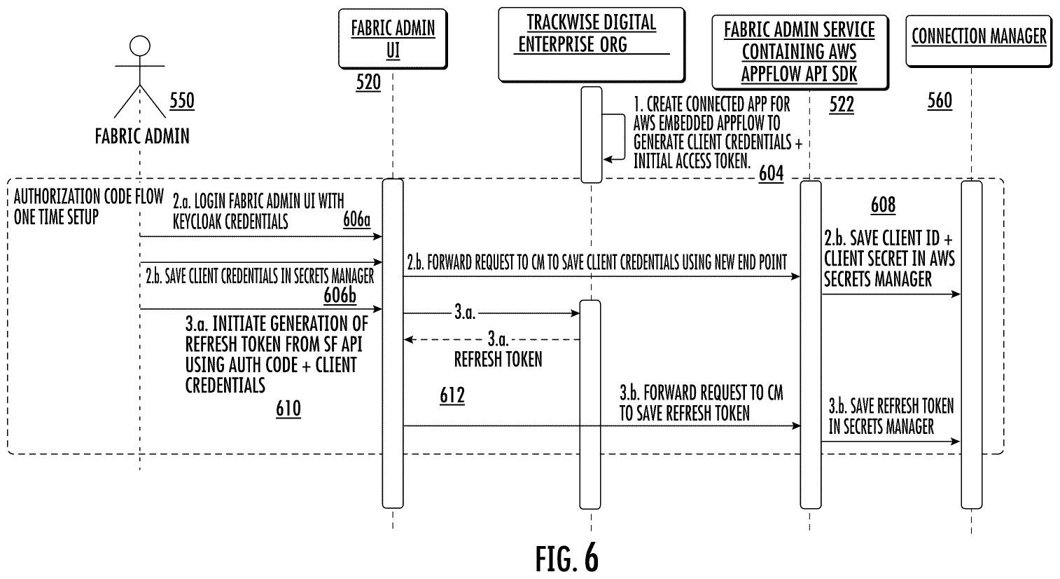

FIG. 6 illustrates a signal diagram 600 of an example authorization code flow in accordance with at least one example embodiment of the present disclosure. The authorization code flow may be configured to facilitate or otherwise provide a secure data intake connection. As shown in FIG. 6, a connected application may be created 604 (e.g., via trackwise digital enterprise organization such as, for example, trackwise digital salesforce enterprise org) to generate client credentials and/or initial access token. In some examples, connected app may be created for AWS embedded AppFlow to generate client credentials and initial access token. Client credentials and/or a request to store the client credentials may be received 606a-b via the fabric admin user interface 520. Storing the client credentials may comprise securely saving the client credentials in a secure storage such as secure repository associated with a connection manager 560 or secrets manager. The fabric admin service 522 may receive indication of the request to store the client credentials via the fabric admin user interface 520 and cause the connection manager 560 to store 608 the client credentials. The connections manager 560 may comprise circuitry (e.g., including one or more repositories) configured to securely store the client credentials. In some embodiments, the connection manager may comprise circuitry configured to direct, instruct, or otherwise cause a secrets manager to store the client credentials.

Indication of a refresh token generation request may be received 610 via the fabric admin user interface 520. The request for example may be a request to initiate generation of refresh token from an external API using an authorization code and the client credentials. In response, a refresh token 612 may be received via the fabric admin user interface 520 and stored via the secrets manager. In the illustrated example, the client credentials 606a, request 606b to store the client credentials, and/or request token generation request may originate from a fabric admin agent 550. The fabric admins agent may comprise a computing device. In some embodiments, the fabric admin agent 550 may comprise a computing device associated with the data intake integration system 102. In some embodiments, the fabric admin agent 550 may comprise a computing device associated with an enterprise.

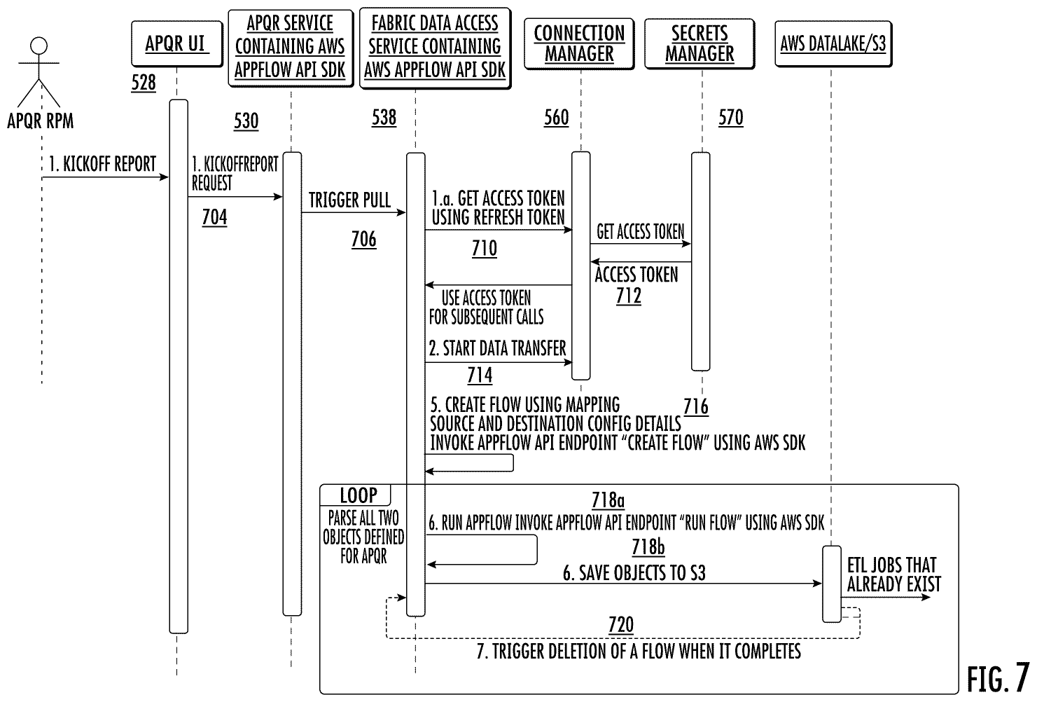

FIG. 7 illustrates a signal diagram of an example workflow generation framework 700 in accordance with at least one example embodiment of the present disclosure. As shown in FIG. 7, the report service 530 (such as APQR report service 530, or the like) may receive a workflow generation request 704 (e.g., corresponding to a report generation request) via a report user interface 528 such as, for example, APQR user interface and trigger 706 a data pull by the fabric data access service 538. The fabric data access service 538, in response, may retrieve 710 an access token from the connection manager using a refresh token (e.g., as described above). As shown in FIG. 7, to retrieve the access token, the fabric data access service 538 may transmit a request (e.g., a Get request, or the like) for an access token to the connection manager 560.

The connection manger 560, in response, may retrieve the access token from the secrets manager 570 (e.g., using the refresh token). For example, the connection manager 560 may transmit a request for the access token to the secrets manager 570, wherein the request may include the refresh token. In some embodiments, the connection manager 560 may be configured to perform one or more verification, validation, authorization, and/or authentication operations based at least in part on the refresh token before retrieving the access token from the secrets manager 570.

The secrets manager may transmit the access token to the connections manager 560. In some embodiments, the secrets manager 570 may be configured to perform one or more verification, validation, authorization, and/or authentication operations based at least in part on the refresh token before providing the access token to the connection manager 560. The connection manager 560, in response, may transmit 712, the access token to the fabric access service. In some embodiments, the access token may be configured for use for subsequent calls.

In response to receiving the access token, the fabric data access service 538 may transfer 714 data (e.g., received and/or retrieved from one or more data sources associated with an enterprise based on a corresponding job data object) to the connection manager 560. The fabric data access service 538 may create 716 a workflow (e.g., application workflow) using mapping source and destination configuration data. The fabric data access service 538 may execute 718a the workflow and store 718b objects associated with the workflow to a database such as, for example, S3 database (as described above). In some embodiments, the fabric data access service 538 may receive an indication, trigger 720, or the like upon completion of the workflow, to delete the workflow.

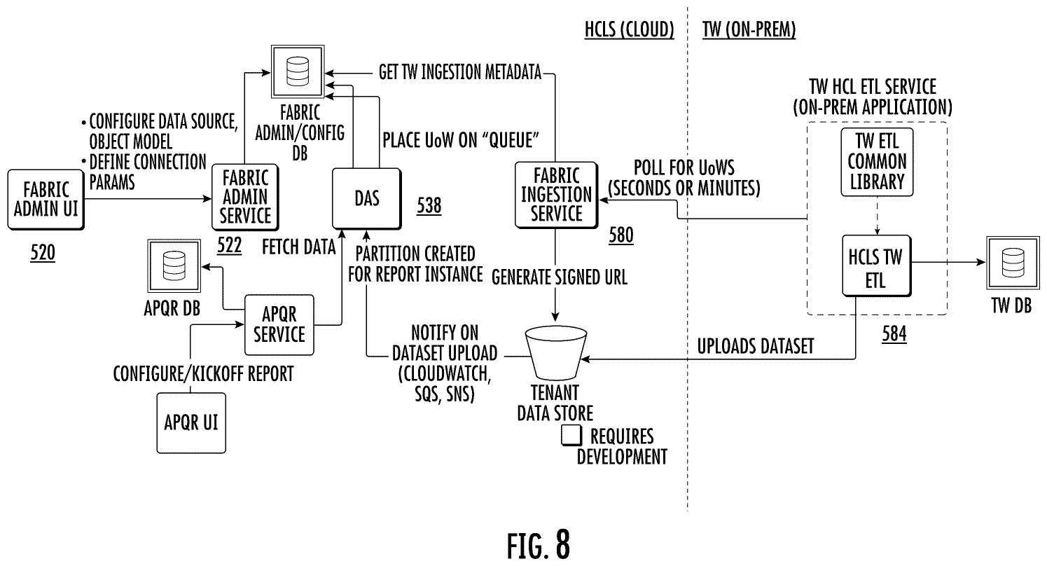

FIG. 8 illustrates an example data flow 800 for an example push-based data integration connection in accordance with at least one example embodiment of the present disclosure. In particular FIG. 8 illustrates an example data flow 800 for a push-based data intake connection for integrating with a system such as trackwise (TW) ETL.

The fabric admin user interface 520 may be leveraged to setup the TW ETL and register client on-premises service. For example, the fabric admin user interface 520 may be leveraged to define database credentials, ingest configuration data, and associate object model with fields being pulled from TW system. Further, the fabric admin user interface 520 may be leveraged to create user interfaces for defining data source((s) and/or object models.

The fabric admin service 522 may be leveraged to define data source type (e.g., new data source type). The fabric admin service 522 may be leveraged to create keycloak client and respond with client configuration identification/secret to configure on-premises service. The fabric admin service may be configured enable the fabric admin agent to define projects and/or data fields to pull from the TW system and/or define or indicate data fields that represent start/end date and/or product (e.g., for query predicates).

The fabric data access service 538 may be configured to add logic to support new data source, listen for events (e.g., such as S3 events) on the TW dataset upload, and/or integrate with existing data upload validation cycle. For example, data from the TW system may be associated with multiple objects represented in one dataset. In this regard, logic and/or algorithm to break up the dataset to conform to object models may be defined via the fabric data access service 538. Further, the fabric data access service 538 may be configured to fetch ingestion metadata from the TW system (e.g., TW ingestion metadata) such as project, data fields, and/or the like from a database associated with a fabric admin agent (e.g., fabric admin database) and/or store ETL unit of work(UoW) in a new database table, discriminated by tenant id. In this regard, the fabric data access service 538 may comprise logic/algorithm configured for requesting TW ETL (e.g., placing a unit of work on a queue)

The fabric ingestion service 580 may be configured for fetching any ETL unit of work for a given tenant and/or marking the unit of work as “collection in progress”.

The ETL service 584 (e.g., HCLS TW ETL Service) may be configured to regularly poll (which polling may be configurable) the fabric ingestion service with a token for ETL unit of work execution. For example, the ETL service may be configured to derive a token from tenant id. The ETL service may comprise information that describes which projects and/or fields to pull data from. In this regard the ETL service may be configured to map or otherwise identify which data fields represent date range and product to enable filtering based on date range and/or product.

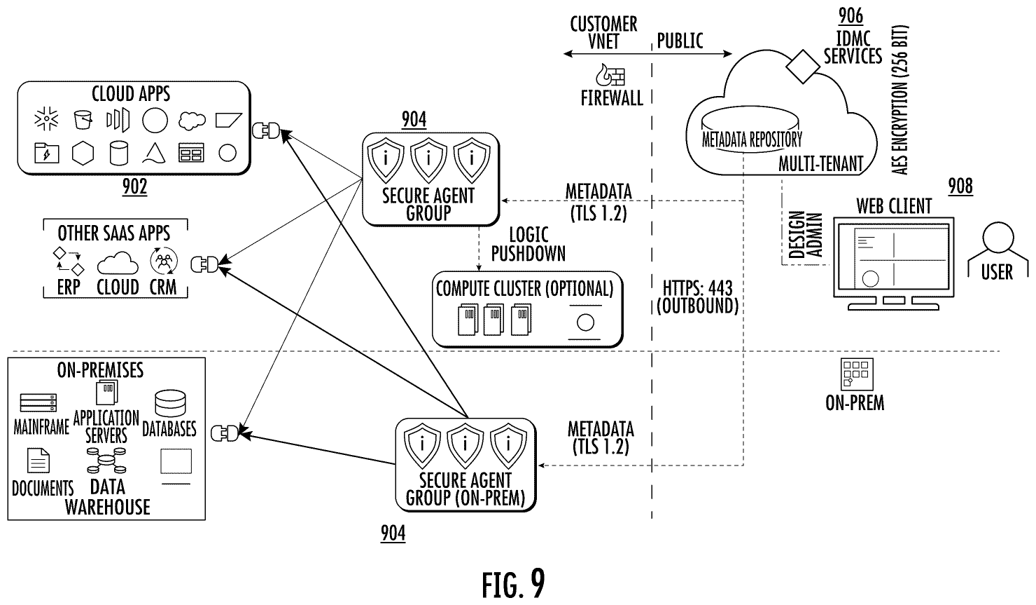

FIG. 9 illustrates an example system architecture 900 for data integration with an external system of records in accordance with at least one example embodiment of the present disclosure. As shown in FIG. 9, the system architecture 900 may include various cloud applications 902 (e.g., including various third-party cloud applications), secure agents 904, one or more services/microservices 906 (e.g., IDMC services), web client/user interface 908, and/or other components (e.g., devices, systems, applications, and/or the like communicatively coupled to provide data integration capability with an external system of records.

### CONCLUSION

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Details regarding various embodiments of the present disclosure are described in the documents in the following pages, which are herein incorporated by reference. Specifically, the documents in the following pages as appendices illustrate various embodiments of the present disclosure.

What is claimed is:

1. A computer-implemented method for robust data integration, the method comprising:
configuring at least one computing device to establish at least one connection by any one of a plurality of data intake connection types, each data intake connection type configured to facilitate the connection between the at least one computing device with at least one external computing device to access source data stored via the at least one external computing device via a distinct data access protocol;
generating a job data object defining at least one data intake connection type of the plurality of data intake connection types accessing particular source data associated with the job data object on at least one particular external computing device;
generating a filtered job data object by applying one or more filter data objects to the job data object; and
retrieving relevant data from the source data by executing the filtered job data object, wherein executing the filtered job data object comprises mapping of a data schema associated with the source data to an enterprise object model and accessing the particular at least one external computing device based at least in part on the at least one connection and the filter data objects.

2. The computer-implemented method of claim 1, further comprising:
executing at least one workflow based on the relevant data.

3. The computer-implemented method of claim 1, further comprising:
storing the enterprise object model in an enterprise object model database associated with a plurality of entities, and processing the stored enterprise object models to generate one or more global enterprise object models.

4. The computer-implemented method of claim 1, wherein the plurality of data intake connection types comprises manual upload, pull digital integration, and push integration.

5. The computer-implemented method of claim 1, wherein the distinct data access protocol comprises one of direct database access, locally hosted APL, client hosted API.

6. The computer-implemented method of claim 1, wherein the job data object comprises one or more of data source URL, data destination URL, authentication data, or data fields defined by one or more object types.

7. The computer-implemented method of claim 1, wherein generating the job data object comprises receiving the job data object from the at least one external computing device.

8. The computer-implemented method of claim 1, wherein the one or more filter data objects comprise one or more of date range, site information, or batch data.

9. The computer-implemented method of claim 1, wherein mapping of a data schema associated with the source data to an enterprise object model comprise mapping an object type associated with the source data table to an object type associated with a data destination table.

10. An apparatus for robust data integration, the apparatus comprising at least one processor and at least one memory storing instructions that, when executed by the at least one processor, cause the apparatus to:
configure at least one computing device to establish at least one connection by any one of a plurality of data intake connection types, each data intake connection type configured to facilitate the connection between the at least one computing device with at least one external computing device to access source data stored via the at least one external computing device via a distinct data access protocol;
generate a job data object defining at least one data intake connection type of the plurality of data intake connection types accessing particular source data associated with the job data object on at least one particular external computing device;
generate a filtered job data object by applying one or more filter data objects to the job data object;
retrieve relevant data from the source data by executing the filtered job data object, wherein executing the filtered job data object comprises mapping of a data schema associated with the source data to an enterprise object model and accessing the particular at least one external computing device based at least in part on the at least one connection and the filter data objects; and
execute at least one workflow based on the relevant data.

11. The apparatus of claim 10, wherein the apparatus is further caused to:
execute at least one workflow based on the relevant data.

12. The apparatus of claim 10, wherein the apparatus is further caused to:
store the enterprise object model in an enterprise object model database associated with a plurality of entities, and process the stored enterprise object models to generate one or more global enterprise object models.

13. The apparatus of claim 10, wherein the plurality of data intake connection types comprises manual upload, pull digital integration, and push integration.

14. The apparatus of claim 10, wherein the distinct data access protocol comprises one of direct database access, locally hosted API, client hosted API.

15. The apparatus of claim 10, wherein the job data object comprises one or more of data source URL, data destination URL, authentication data, or data fields defined by one or more object types.

16. The apparatus of claim 10, wherein generating the job data object comprises receiving the job data object from the at least one external computing device.

17. The apparatus of claim 10, wherein the one or more filter data objects comprise one or more of date range, site information, or batch data.

18. The apparatus of claim 10, wherein mapping of a data schema associated with the source data to an enterprise object model comprise mapping an object type associated with the source data table to an object type associated with a data destination table.

19. A computer program product for robust data integration, the computer program product comprising at least one non-transitory computer-readable storage medium, the at least one non-transitory computer-readable storage medium including instructions that when executed by at least one processor, cause the computer program product to:
configure at least one computing device to establish at least one connection by any one of a plurality of data intake connection types, each data intake connection type configured to facilitate the connection between the at least one computing device with at least one external computing device to access source data stored via the at least one external computing device via a distinct data access protocol;
generate a job data object defining at least one data intake connection type of the plurality of data intake connection types accessing particular source data associated with the job data object on at least one particular external computing device;
generate a filtered job data object by applying one or more filter data objects to the job data object;
retrieve relevant data from the source data by executing the filtered job data object, wherein executing the filtered job data object comprises mapping of a data schema associated with the source data to an enterprise object model and accessing the particular at least one external computing device based at least in part on the at least one connection and the filter data objects; and
execute at least one workflow based on the relevant data.

20. The computer program product of claim 19, wherein the at least one non-transitory computer-readable storage medium including instructions that when executed by the at least one processor, further cause the computer program product to:
execute at least one workflow based on the relevant data.
